(19) United States
(12) Patent Application Publication
(10) Pub. No.: US 2008/0065376 A1
(43) Pub. Date: Mar. 13, 2008

(54) Audio encoder

(75) Inventor: Masataka Osada, Kawasaki-shi (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: KABUSHIKI KAISHA TOSHIBA, Tokyo (JP)

(21) Appl. No.: 11/647,972

(22) Filed: Jan. 2, 2007

(30) Foreign Application Priority Data
Sep. 8, 2006 (JP) 2006-244578

(51) Int. Cl. G10L 19/00

(52) U.S. Cl. 704/230

(57) ABSTRACT

As adaptive convergence A, a global gain for operation of a quantization step size is obtained, a frequency spectrum is quantized on the basis of the obtained global gain, and a generated code amount of the quantized data is obtained by the quantization. If the generated code amount does not satisfy predetermined conditions as a result of comparison with a target code amount, the adaptive convergence A is executed again. At this time, generated code amount variation α is obtained by varying the global gain by 1, the global gain is corrected with the adaptive convergence A of the previous time on the basis of the generated code amount variation α, and the adaptive convergence A is executed with the corrected global gain.

### CROSS-REFERENCE TO RELATED APPLICATIONS

This application is based upon and claims the benefit of priority from prior Japanese Patent Application No. 2006-244578, filed Sep. 8, 2006, the entire contents of which are incorporated herein by reference.

### BACKGROUND OF THE INVENTION

1. Field of the Invention

The present invention relates to an audio encoder encoding audio signals.

2. Description of the Related Art

When an audio encoder encodes audio data, the audio encoder determines a quantization step size so as to satisfy a target bit rate. Binary search can be used to obtain an optimum quantization step size in AAC (Advanced Audio Coding).

By the way, Japanese Patent No. 2655063 discloses a technique where a quantization step size is calculated and it is estimated whether first bit amount, which is generated in the quantization process by using the quantization step size, satisfies the target bit rate. If the first bit amount satisfies the target bit rate, the encoding process is terminated. However if the fist bit amount does not satisfy the target bit rate, the quantization step size again calculated to be used for calculating second bit amount.

According to this technique, if the difference between the first bit amount and the target bit rate is equal to or more than N, second estimation of the quantization step size is executed such that the bit amount becomes less than the first encoding amount. On the other hand, if the difference is smaller than N, second estimation of the quantization step size is executed by updating the first quantization step by one step.

In the method of this technique, if differential threshold value N is small, a convergence rate depends on the accuracy of estimation but the estimating method is not disclosed. In any of the above cases according to the method of this technique, if the target is satisfied at higher than the differential threshold value N by the estimation, the estimation may not be terminated in the vicinity of the target.

The conventional audio encoder has a problem that there is much average processing amount required for search for the quantization step size and the search may not be terminated in the vicinity of the target.

### BRIEF SUMMARY OF THE INVENTION

The present invention has been accomplished to solve the above-described problems. The object of the present invention is to provide an audio encoder capable of reducing the average processing amount by reducing the number of times of the search for the quantization step size, and then enhancing the searching accuracy.

To achieve this object, an aspect of the present invention comprises conversion means for converting a signal in a time domain into a frequency spectrum in a frequency domain, in relation to an audio signal, first detection means for obtaining a target bit amount in accordance with the frequency spectrum, second detection means for obtaining a scale factor in accordance with the frequency spectrum, and loop controlling means comprising quantization means, third detection means and correction means, for executing loop control with loop formed by the quantization means, third detection means and correction means. The quantization means obtains quantized data by quantizing the frequency spectrum, in accordance with a quantization step size corrected by the correction means and the scale factor. The third detection means obtains variation of a bit amount of the data, in accordance with the quantized data obtained by the quantization means at each loop control. The correction means corrects the quantization step size used by the quantization means, in accordance with the variation obtained by the third detection means and the target bit amount.

In the present invention, as described above, the variation in the bit amount of the data is obtained on the basis of the quantized data obtained for each loop control by the quantizing means, and quantization step size used by the quantizing means is corrected on the basis of the obtained variation and the target bit amount.

Thus, since the quantization can be executed by varying the quantizing step in accordance with the variation in the encoding amount of the quantized data, the average processing amount can be reduced by reducing the number of times of the search for the quantization step size and the searching accuracy can be thereby enhanced.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a block diagram showing a configuration of an audio encoder according to an embodiment of the present invention;

FIG. 2 is a block diagram showing a configuration of a quantization controller in the audio encoder shown in FIG. 1;

FIG. 3 is a flowchart describing operations of the quantization controller in the audio encoder shown in FIG. 1; and

FIG. 4 is a graph describing a state in which the relation between the target code amount and the generated code amount becomes opposite while adaptive convergence A shown in FIG. 3 is repeated.

### DETAILED DESCRIPTION OF THE INVENTION

An embodiment of the present invention will be described with reference to the accompanying drawings.

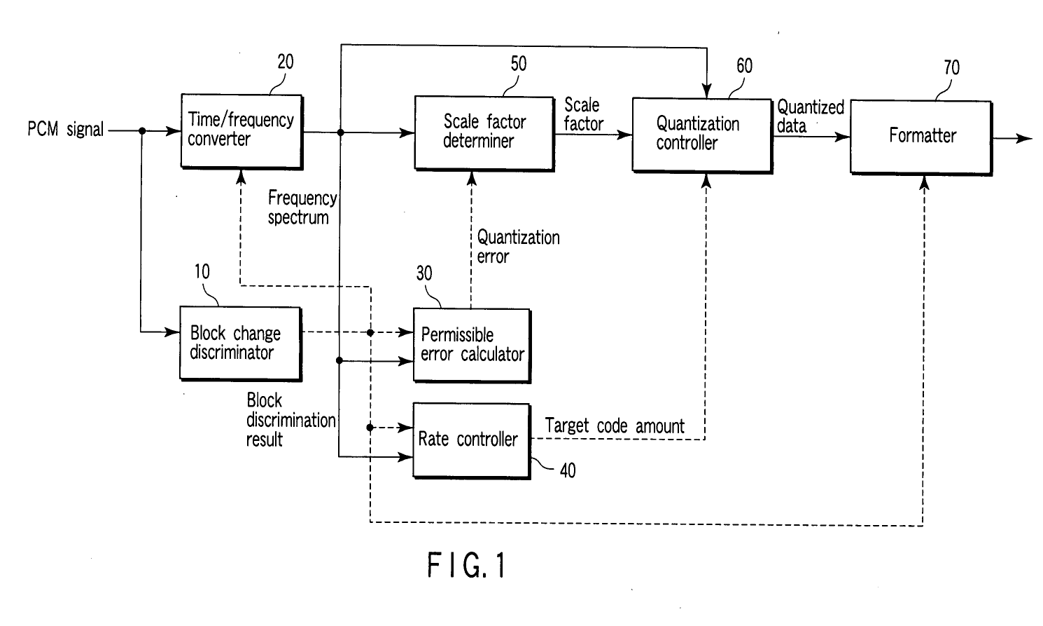

FIG. 1 shows a configuration of an audio encoder according to the embodiment of the present invention. In this embodiment, an AAC (Advanced Audio Coding) encoder is explained. The audio encoder comprises a block change discriminator 10, a time/frequency converter 20, a permissible error calculator 30, a rate controller 40, a scale factor determiner 50, a quantization controller 60, and a formatter 70.

The block change discriminator 10 detects signal characteristics of an input PCM signal (audio signal) and discriminates whether a long block or a short block should be selected, on the basis of the characteristics. In general, when a transitional signal such as an attack sound is input, the short block is selected but is not particularly limited here. The discrimination result is output to the time/frequency converter 20, the permissible error calculator 30, the rate controller 40, and the formatter 70.

The time/frequency converter 20 converts from a time domain signal into a frequency band signal, as the input PCM signal, with a block based on the discrimination result of the block change discriminator 10 and obtains frequency spectrum of the PCM signal. The frequency spectrum is output to the permissible error calculator 30, the rate controller 40, the scale factor determiner 50, and the quantization controller 60.

The permissible error calculator 30 calculates a quantization error (hereinafter called permissible quantization error) for each frequency band of the frequency spectrum, on the basis of a psycho-audio model. The permissible quantization error implies the quantization error of the range which can hardly be sensed by a listener due to the masking effect. By the quantization based on the permissible quantization error, the bit amount generated by encoding process can be saved without degrading the quality.

The rate controller 40 calculates the target bit amount of a current frame, on the basis of the block shape selected by the block change discriminator 10 and the frequency spectrum obtained by the time/frequency converter 20. The target bit amount is output to the quantization controller 60.

The scale factor determiner 50 calculates a scale factor (scale_factor [sfb]) which satisfies the permissible quantization error obtained by the permissible error calculator 30 for each of the frequency bands of the frequency spectrum obtained by the time/frequency converter 20. Various kinds of methods can be employed as this calculating method, but the method is not particularly limited.

The quantization controller 60 obtains quantization data by quantizing the frequency spectrum obtained by the time/frequency converter 20, on the basis of the scale factor obtained by the scale factor determiner 50 and the target bit amount obtained by the rate controller 40. Details of the processing of the quantization controller 60 will be described later.

The formatter 70 converts the quantization data obtained by the quantization controller 60 into encoded information, on the basis of a predetermined syntax based on the block shape selected by the block change discriminator 10, and stores temporarily and outputs the encoded information.

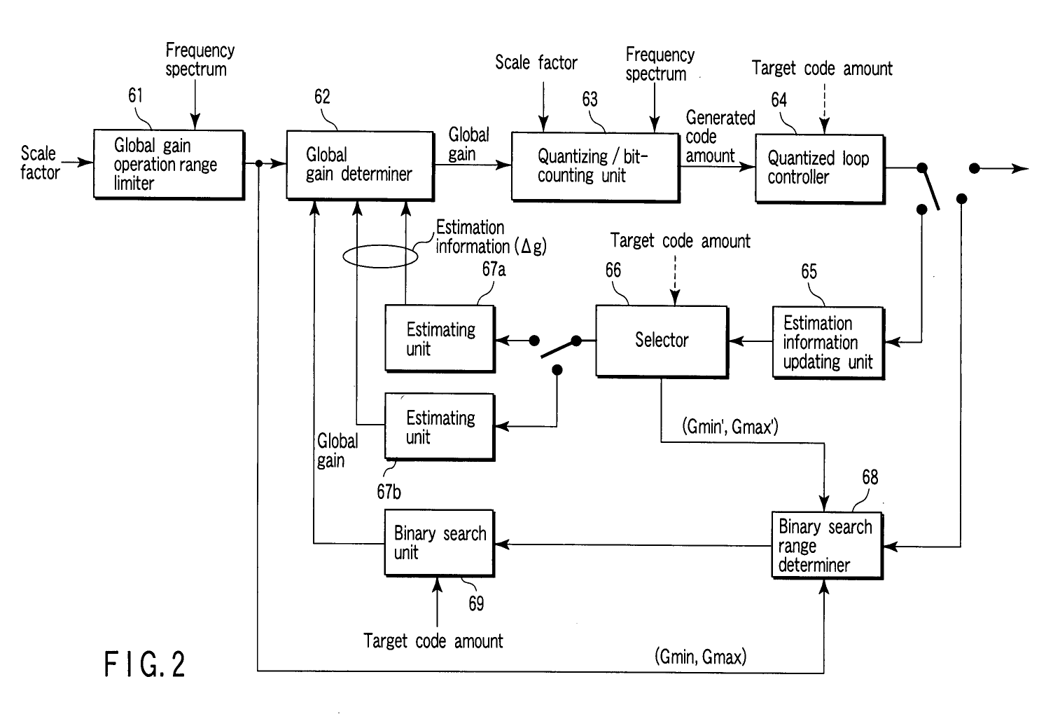

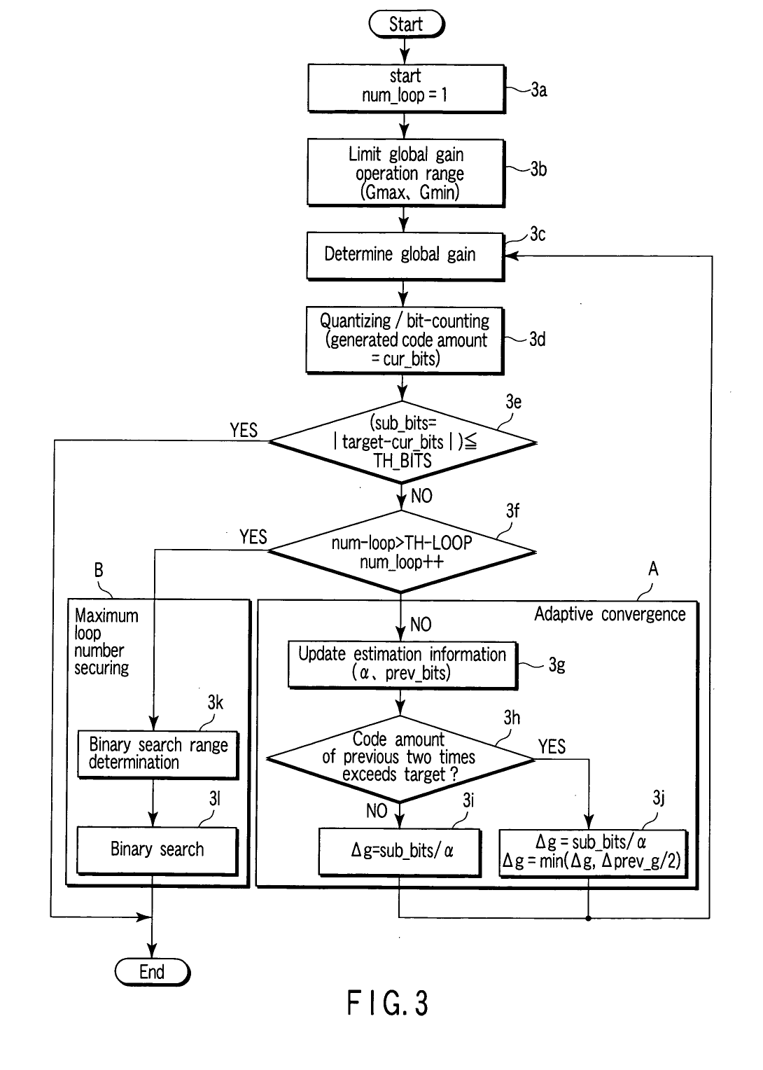

Next, the processing of the quantization controller 60 is described in detail with reference to FIG. 2 and FIG. 3. FIG. 2 shows an example of the configuration of the quantization controller 60. FIG. 3 shows a flowchart showing the processing (quantization control) to obtaining the quantization data, by the quantization controller 60 having the configuration shown in FIG. 2. This processing is executed for each frame.

First, in step 3a, a quantization loop controller 64 sets parameter num_loop representing the number of loops at initial value “1” as the initial value and proceeds to step 3b.

In step 3b, a global gain operation range limiter 61 limits an operation range (Gmin, Gmax) of a global gain which is a parameter for operation of a quantizing step common to all the bands, on the basis of the frequency spectrum output from the time/frequency converter 20 and the scale factor (scale_factor [sfb]) determined by the scale factor determiner 50. A global gain determiner 62 and a binary search range determiner 68 are notified of this operation range (Gmin, Gmax).

More specifically, the global gain operation range limiter 61 substitutes the scale factor (scale_factor [sfb]) for a definition formula (1) of quantization in the AAC encoding:

x=int[{abs(mdct_line)×(2(scale_factor[sfb]−global_gain)/4)}^{3/4}+0.4054] (1)

Formula (1) can be transformed to the following formula (2).

x=int[{abs(mdct_line)×2^{scale}_{^{—}}^{factor[sfb]/4}}^{3/4}×2^{-3·global}_{^{—}}^{gain/16}+0.4054] (2)

In formula (2), a maximum value in a frame of the following term is obtained. In the formula, “mdct_line” and “scale_factor [sfb]” are already determined.

{abs(mdct_{—line)×}2^{scale}_{^{—}}^{factor[sfb]/4}}^{3/4}

The obtained maximum value of the term is set as Amax as indicated by the following formula (3).

Amax={abs(mdct_line)×2^{scale}_{^{—}}^{factor[sfb]/4}}^{3/4} (3)

Since a range of a Huffman code table of the AAC is 0 to 8191, the quantization value needs to satisfy the following formula (4).

0≦int[Amax×2^{-3/16·global}_{^{—}}^{gain}+0.4054]≦8191 (4)

When the calculation continues using the global gain by which the quantization value is 0.8191 as Gmin and Gmax, the following formula (5) is obtained.

$$G min - G max = \frac{16}{3} \times log 2 ( \frac{8191.5946}{0.5946} ) ≅ 74 \qquad ( 5 )$$

In other words, since the variable range of the global gain is limited by the following formula (6), the global gain operation range limiter 61 obtains this range as the variable range of the global gains.

Gmin≦global_gain≦Gmin+74 (6)

Since the variable range of the global gain under the AAC standard is a range of 255, there is an effect of reducing the search range by smaller than one third by the formula (6) and the processing amount of the quantization control can be reduced. In the subsequent quantization control, global gain search is executed in the range of the formula (6) obtained by the global gain operation range limiter 61, in the following manner.

In step 3c, the global gain determiner 62 determines the global gain in the operation range limited by the global gain operation range limiter 61, on the basis of an initial value table or estimation information, and outputs the determined global gain to a quantizing/bit-counting unit 63. The global gain of the previous frame is preliminarily maintained in the initial value table. In other words, since there is no estimation information obtained by the previous loop at the first quantization loop, the global gain determiner 62 sets the global gain of the previous frame as the initial value.

At the second loop and the following loops, the global gain determiner 62 sets a value obtained by the following formula (7) as the global gain, by using a global gain change amount (Δg) obtained in an adaptive convergence processing A to be described later. In the formula, “prev_global_gain” indicates the global gain at the previous loop.

Aglobal_gain=prev_global_gain+Δg (7)

In step 3d, the quantizing/bit-counting unit 63 determines a quantization step size on the basis of the global gain obtained in step 3c by the global gain determiner 62 and the scale factor (scale_factor [sfb]) determined by the scale factor determiner 50, quantizes and Huffman-encodes the frequency spectrum output from the time/frequency converter 20 on the basis of the determined quantization step size, and counts the generated bit amount, to obtain the generated bit amount (cur_bits). The quantized data and generated bit amount (cur_bits) thus obtained, and the global gain obtained in step 3c by the global gain determiner 62 are output to the quantized loop controller 64.

In step 3e, the quantized loop controller 64 discriminates whether or not the convergence conditions of the quantization control are satisfied, on the basis of the generated bit amount (cur_bits) obtained in step 3d by the quantizing/bit-counting unit 63. In other words, the quantized loop controller 64 first obtains a difference (sub_bits) between the generated bit amount (cur_bits) obtained in step 3d and the target bit amount obtained by the rate controller 40, compares the difference (sub_bits) with a preset threshold value (TH_BITS), and discriminates whether or not the difference (sub_bits) satisfies the following formula (8).

sub_bits=|target−cur_bits|≦TH_BITS (8)

If the difference (sub_bits) satisfies the formula (8), the quantized data output from the quantizing/bit-counting unit 63 is output to the formatter 70 by considering that the desired generated bit amount has been implemented, and this processing (quantization control) is ended.

On the other hand, if the difference (sub_bits) does not satisfy the formula (8), i.e. if the difference (sub_bits) does not satisfy the convergence condition of the quantization control, the operation shifts to step 3f. In prior art, the generated bit amount (cur_bits) has been controlled to be below the target as shown in the following formula.

0<sub_bits=target−cur_bits≦TH_BITS

The quantized loop controller 64 executes loose control under the convergence conditions including margin. Thus, if the bit reserver does not underflow, the quantized loop controller 64 can converge the generated bit amount even in a case of cur_bits>target as shown in formula (8), and can reduce the time necessary for convergence while maintaining the audio quality.

In step 3f, the quantized loop controller 64 discriminates which of adaptive convergence A for executing adaptive global gain estimation responding to the signal characteristics and maximum loop number securing B for executing global gain estimation by the binary search, should be executed in response to the number of times of loops (num_loop). After the discrimination, the quantization loop controller 64 increments the number of loops (num_loop) by one.

In other words, if the number of times of loops (num_loop) is equal to or smaller than a determined value (TH_LOOP), the quantization loop controller 64 outputs to an estimation information updating unit 65 the global gain supplied from the quantizing/bit-counting unit 63, the difference (sub_bits) of the target bit amount (target), and the generated bit amount (cur_bits) supplied from the quantizing/bit-counting unit 63, to execute the adaptive convergence A. The operation shifts to step 3g.

On the other hand, if the number of times of loops (num_loop) exceeds the determined value (TH_LOOP), the quantization loop controller 64 orders the binary search range determiner 68 to determine the search range in order to forcefully converge the generated bit amount by the maximum loop number securing B. The operation shifts to step 3k.

If the number of times of loops (num_loop) first exceeds the determined value (TH_LOOP), the quantization loop controller 64 only orders the binary search range determiner 68. If the number of times of loops (num_loop) exceeds the determined value (TH_LOOP) for the second time or more time, the quantizing/bit-counting unit 63 outputs to the quantization loop controller 64 the generated bit amount and the global gain obtained by the maximum loop number securing B (binary search) to be described later. Thus, the generated bit amount and the global gain required for the maximum loop number securing B are output to the binary search range determiner 68.

In step 3g, the estimation information updating unit 65 stores the global gain at the previous loop, and stores the generated bit amount (cur_bits) at the previous loop as the generated bit amount (prev_bits). On the basis of these, and the global gain and generated bit amount (cur_bits) supplied from the quantization loop controller 64, the estimation information updating unit 65 obtains generated bit amount variation α when the global gain is varied by 1.

The following formula (9) is an example of formula obtaining the generated bit amount variation α. In this example, the estimation information updating unit 65 obtains the generated bit amount variation α, on the basis of the difference Δg between the global gain of the previous loop and the global gain of the current loop, the generated bit amount (prev_bits) of the previous loop, and the generated bit amount (cur_bits) of the current loop.

$$α = \frac{cur\_bits - prev\_bits}{Δ g} \qquad ( 9 )$$

Thus, not the result f the immediately previous loop, but the result of the further previous loop may be used or the results of a plurality of loops may be used. Since prev_bits is unstable at the first loop, the initial value of α may not be determined by the formula (9), but may be set at a determined value, for example, 130 bits. This is an empirical value in encoding with general acoustic sources, but does not limit the range of the initial value.

After the generated bit amount variation α is obtained, the estimation information updating unit 65 outputs to a selector 66 the generated bit amount variation α, the difference (sub_bits) supplied from the quantization loop controller 64, the generated bit amount (cur_bits) at the current loop, the generated bit amount (prev_bits) at the previous loop, and the global gain of the current loop. After the output, the estimation information updating unit 65 maintains the generated bit amount (cur_bits) at the current loop as the generated bit amount (prev_bits) at the previous loop, in preparation for a next loop. The same operation is also executed for the global gain.

In step 3h, the selector 66 maintains the global gain of the current loop supplied from the estimation information updating unit 65, and maintains again the global gain of the previous loop maintained at this time as the global gain of the previous loop. The selector 66 selects an estimating unit 67a or an estimating unit 67b to estimate the global gain variation at the next loop, on the basis of the generated bit amount (prev_bits) at the previous loop, the generated bit amount (cur_bits) at the current loop, and the target bit amount.

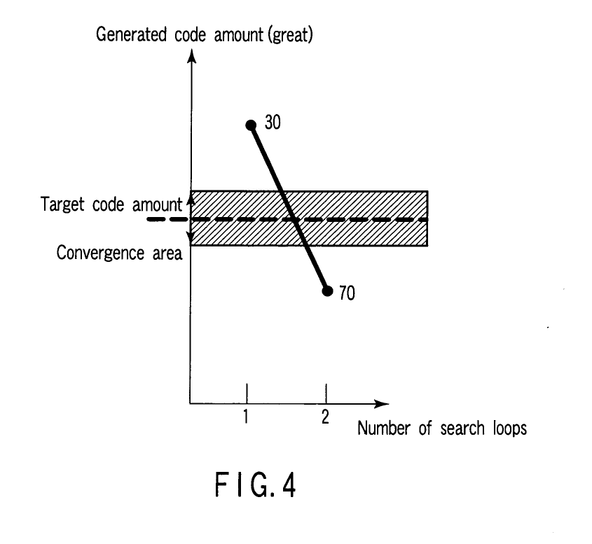

More specifically, the selector 66 discriminates whether or not the generated bit amount (cur_bits) at the current loop is varied from the generated bit amount (prev_bits) at the previous loop to the value which exceeds the target bit amount. If the generated bit amount (cur_bits) at the current loop is not varied to the value which exceeds the target bit amount, the operation shifts to step 3i. If the generated bit amount (cur_bits) at the current loop is varied to the value which exceeds the target bit amount, the operation shifts to step 3j. As shown in FIG. 4, for example, the generated bit amount is less than the target bit amount at the initial loop. When the generated bit amount is more than the target bit amount and vice versa at the second loop, the operation shifts to step 3j.

In the case where the generated bit amount (cur_bits) at the current loop is varied to the value which exceeds the target bit amount, the global gain of the current loop and the global gain of the previous loop maintained at this time are global gains which are bases of the quantization step size to obtain end points (cur_bits, prev_bits) on both sides of the target. Thus, the smaller global gain is output as Gmin′ and the greater global gain is output as Gmax′, to the binary search range determiner 68.

If the global gains (Gmin′, Gmax′) have been already output to the binary search range determiner 68 at this time, the global gains (Gmin′, Gmax′) obtained at this time are employed in the binary search range determiner 68.

In step 3i, the selector 66 outputs to the estimating unit 67a the generated bit amount variation α and the difference (sub_bits) that are supplied from the estimation information updating unit 65 to the estimating unit 67a. The estimating unit 67a thereby obtains global gain variation (Δg) at the next loop, in the following formula (10). The global gain variation (Δg) is output to the global gain determiner 62 as the estimation information.

$$Δ g = \frac{sub\_bits}{α} \qquad ( 10 )$$

In step 3j, the selector 66 outputs to the estimating unit 67a the generated bit amount variation α and the difference (sub_bits) that are supplied from the estimation information updating unit 65 to the estimating unit 67b. The estimating unit 67b thereby obtains the global gain variation (Δg), in the above formula (10). The estimating unit 67b has maintained the global gain variation (Δg) of the previous loop, and obtains the global gain variation (Δg) of the next loop in the following formula (11) using the global gain variation (Δg) of the previous loop. The estimating unit 67b outputs the global gain variation (Δg) of the next loop to the global gain determiner 62 as the estimation information.

Δg=min(Δg, Δprev_{—}g/2) (11)

In other words, when the selector 66 selects the estimating unit 67b, the generated bit amount (cur_bits) at the current loop becomes the value which exceeds the target bit amount from the generated bit amount (prev_bits) at the previous loop. Therefore, the maximum global gain variation at the next loop becomes the same as that in the binary search and the dispersion of the quantization control can be prevented.

Thus, the operation returns to step 3c with Δg estimated by the estimating unit 67a or 67b and the global gain of the next loop is determined. In either the estimating unit 67a or the estimating unit 67b, Δg is a positive value when the generated bit amount (cur_bits) at the current loop is greater than the target bit amount while Δg is a negative value when the generated bit amount (cur_bits) at the current loop is smaller than the target bit amount. In other words, Δg has a symbol representing the variation of the generated bit amount in the direction of being close to the target bit amount.

In step 3k, the binary search range determiner 68 ordered to determine the search range by the quantization loop controller 64 in step 3f adds further limitations to the global gain operation range (Gmin, Gmax) obtained in step 3b in order to efficiently execute the binary search. In the formula (6), the global gain operation range is limited to 74. When the binary search is executed under this condition, the search needs to be executed at seven times until the convergence.

If the movable range of the global gain is limited to 64 as represented by the following formula (12), the number of searches required until the convergence is six and the number of loops can be further reduced. In case where the movable range is limited as represented by the following formula (12), the high-accuracy quantization step size is excluded from the search range, but deterioration in the quality of the encoded sounds was not recognized according to the sound quality evaluation executed by the present inventor(s). The binary search range determiner 68 updates Gmin to Gmin+10.

Gmin+10≦global_gain≦Gmin+74(=Gmax) (12)

In step 3k, if (Gmin′, Gmax′) have been output to the binary search range determiner 68 in step 3h, the binary search range determiner 68 further limits the operation range of the global gain with (Gmin′, Gmax′) in accordance with the following formula (13). The binary search range determiner 68 notifies a binary search unit 69 of the limited operation range of the global gain.

Gmin=max(Gmin, Gmin′), Gmaxmin(Gmax, Gmax′) (13)

In step 31, the binary search unit 69 executes binary search using the end points of the global gain operation range and determines the global gain. Thus, the global gain satisfying the target bit amount can be thereby found at maximum six times, and the increase in the number of times of abnormal loops can be avoided.

The global gain thus determined is output to the quantizing/bit-counting unit 63 via the global gain determiner 62. The quantizing/bit-counting unit 63 determines the quantization step size on the basis of the global gain obtained by the binary search unit 69 and the scale factor (scale_factor [sfb]) determined by the scale factor determiner 50, and obtains the generated bit amount (cur_bits) by quantizing and Huffman-encoding the frequency spectrum output from the time/frequency converter 20 and counting the generated bit amount, on the basis of the quantization step size.

The quantized data and generated bit amount (cur_bits) thus obtained, and the above global gain are output to the quantization loop controller 64. When the quantized loop controller 64 confirms satisfying the formula (8) on the basis of the generated bit amount (cur_bits) obtained by the quantizing/bit-counting unit 63, the quantized loop controller 64 outputs the quantized data output from the quantizing/bit-counting unit 63 to the formatter 70 and ends this processing (quantization control).

If the quantization loop controller 64 cannot confirm satisfying the formula (8), the quantization loop controller 64 outputs the generated bit amount and global gain obtained at the current loop to the binary search range determiner 68 to execute again the binary search. On the basis of the global gain of the previous loop and the global gain of the current loop, the binary search range determiner 68 determines the range of the binary search and notifies the binary search unit 69 of the determined binary search to execute the binary search.

In the audio encoder having the above-described configuration, as adaptive convergence A, the global gain for operation of the quantization step size is obtained, the frequency spectrum is quantized on the basis of the obtained global gain, and the generated bit amount of the quantized data is obtained on the basis of the quantization. If the generated bit amount does not satisfy predetermined conditions as a result of comparison with the target bit amount, the adaptive convergence A is executed again. At this time, the generated bit amount variation α is obtained by varying the global gain by 1, the global gain is corrected with the previous adaptive convergence A on the basis of the generated bit amount variation α, and the adaptive convergence A is executed with the global gain.

Therefore, since the generated bit amount variation α is obtained by varying the global gain by 1 and the global gain to be used for the quantization is corrected on the basis of the generated bit amount variation α, the average processing amount can be decreased and the search accuracy can be enhanced by reducing the number of searches of the quantization step size.

If the relationship in size between the target bit amount and the generated bit amount is reversed while the adaptive convergence A is repeated, the global gain is corrected on the basis of a smaller value of the corrected value (Δg) based on the generated bit amount variation α and the corrected value (Δprev_g/2) based on the binary search of the previous loop and the adaptive convergence A is executed with the corrected global gain. Therefore, a maximum variation of the global gain at the next loop becomes the same as that in the binary search and the dispersion of the quantization control can be prevented.

Moreover, if the code amount is not converged even by repeating the adaptive convergence A at the predetermined number of times, abnormal increase in the number of loops can be prevented since a binary search (maximum loop number preservation B) adding further limitations to the operation range of the global gain is executed and the bit amount is converged within the maximum number of loops.

The present invention is not limited to the embodiments described above but the constituent elements of the invention can be modified in various manners without departing from the spirit and scope of the invention. Various aspects of the invention can also be extracted from any appropriate combination of a plurality of constituent elements disclosed in the embodiments. Some constituent elements may be deleted in all of the constituent elements disclosed in the embodiments. The constituent elements described in different embodiments may be combined arbitrarily.

For example, the generated bit amount variation α is adaptively updated on the basis of the bit variation amount. Instead of this, however, the generated bit amount variation α may be adaptively updated on the basis of the peak of the quantized value. Otherwise, the generated bit amount variation α may be adaptively updated on the basis of the average value of a plurality of loops of the quantized value. Furthermore, the generated bit amount variation α may be adaptively updated on the basis of the irregularity (sfm, dispersion, etc.) of the quantized value.

In addition, the generated bit amount variation α may be adaptively updated on the basis of irregularity (sfm, dispersion, etc.) of the coefficient before quantization. Furthermore, the generated bit amount variation α may be adaptively updated on the basis of the rate at which the quantized value is zero.

Moreover, the global gain which is the parameter determining the quantization step size is subjected to loop control in the above embodiment. However, the quantization step size may be subjected to loop control. In this case, for example, the selector 66 maintains the quantization step size of the previous loop and the current loop, instead of the global gain of the previous loop and the current loop, and notifies the binary search range determiner 68 of the quantization step size in step 3h. The binary search range determiner 68 limits the range of the binary search on the basis of the quantization step size of the previous loop and the current loop, and the binary search unit 69 executes the binary search on the basis of the result of the limitation.

What is claimed is:

1. An audio encoder, comprising:
conversion means for converting a signal in a time domain into a frequency spectrum in a frequency domain, in relation to an audio signal;
first detection means for obtaining a target bit amount in accordance with the frequency spectrum;
second detection means for obtaining a scale factor in accordance with the frequency spectrum; and
loop controlling means comprising quantization means, third detection means and correction means, for executing loop control with loop formed by the quantization means, third detection means and correction means,
wherein the quantization means obtains quantized data by quantizing the frequency spectrum, in accordance with a quantization step size corrected by the correction means and the scale factor,
the third detection means obtains variation of a bit amount of the data, in accordance with the quantized data obtained by the quantization means at each loop control, and
the correction means corrects the quantization step size used by the quantization means, in accordance with the variation obtained by the third detection means and the target bit amount.

2. The audio encoder according to claim 1, further comprising fourth detection means for detecting a relationship in size between a bit amount of the quantized data and the target bit amount at each loop control,
wherein if the relationship in size is reversed, the correction means corrects the quantization step size used by the quantization means, in accordance with a smaller one of a binary value of a corrected value of the quantization step size used at the loop control on which the reversal is based, and a corrected value based on both the variation obtained by the third detection means and the target bit amount.

3. The audio encoder according to claim 1, further comprising:
fourth detection means for detecting a relationship in size between a bit amount of the quantized data and the target bit amount at each loop control;
memory means for storing a quantization step size used to obtain quantized data before the relationship in size is reversed, and a quantization step size used to obtain quantized data after the relationship in size is reversed;
fifth detection means for detecting number of times of execution of the loop control; and
binary search means for determining the quantization step size by binary search using values based on the quantization step size stored in the memory means as end points, if the number of times of the execution exceeds a preset value.

4. The audio encoder according to claim 1, further comprising sixth detection means for obtaining a difference between the target bit amount and the bit amount of the quantized data,
wherein the loop control means executes the loop control if the difference is greater than a preset value, while the loop control means ends the loop control if the difference is equal to or smaller than the preset value.

5. The audio encoder according to claim 1, further comprising limitation means for limiting an operation range of the quantization step size in accordance with the frequency spectrum and the scale factor,
wherein the correction means corrects the quantization step size within a permissible range limited by the limitation means.

6. An audio encoder, comprising:
conversion means for converting a audio signal in a time domain into a spectrum signal in a frequency domain;
first calculating means for calculating a target bit amount based on the frequency spectrum;
second calculating means for calculating a scale factor based on the frequency spectrum; and
loop controlling means which comprises quantization means, third calculating means, and correction means, for executing loop control,
wherein the quantization means quantizes the frequency spectrum by using a quantization step size modified by the correction means and the scale factor, and obtains quantized data,
the third detection means calculates variation of a bit amount of the quantized data obtained by the quantization means, and
the modification means modifies the quantization step size used by the quantization means based on the variation obtained by the third calculating means and the target bit amount.

7. The audio encoder according to claim 6, further comprising fourth calculating means for calculating a relationship in size between a bit amount of the quantized data and the target bit amount for each loop control,
wherein if the relationship in size is reversed, the modification means modifies the quantization step size used by the quantization means, in accordance with a smaller one of a binary value of a modified value of the quantization step size used at the loop control on which the reversal is based, and a modified value based on both the variation obtained by the third calculating means and the target bit amount.

8. The audio encoder according to claim 6, further comprising:
fourth calculating means for calculating a relationship in size between a bit amount of the quantized data and the target bit amount for each loop control;
memory means for storing a quantization step size used to obtain quantized data before the relationship in size is reversed, and a quantization step size used to obtain quantized data after the relationship in size is reversed;
fifth calculating means for calculating number of times of execution of the loop control; and
binary search means for determining the quantization step size by binary search using values based on the quantization step size stored in the memory means as end points, if the number of times of the execution exceeds a preset value.

9. The audio encoder according to claim 6, further comprising sixth calculating means for calculating a difference between the target bit amount and the bit amount of the quantized data,
wherein the loop control means executes the loop control if the difference is greater than a preset value, while the loop control means ends the loop control if the difference is equal to or smaller than the preset value.

10. The audio encoder according to claim 6, further comprising limitation means for limiting an operation range of the quantization step size in accordance with the frequency spectrum and the scale factor,
wherein the correction means modifies the quantization step size within a permissible range limited by the limitation means.
